(19) United States
(12) Patent Application Publication
(10) Pub. No.: US 2023/0295753 A1
(43) Pub. Date: Sep. 21, 2023

(54) PROCESS FOR ACIDIC HYDROLYSIS OF A PARTICULATE SOLID MATERIAL CONTAINING CELLULOSE, LIGNIN, AND HEMICELLULOSE, WHEREIN THE LATTER HAS A HIGH CONTENT OF XYLOSE

(71) Applicant: Avantium Knowledge Centre B.V., Amsterdam (NL)

(72) Inventors: Jagdeep Singh, Amsterdam (NL); Martijn Kersbulck, Amsterdam (NL); Benjamin McKay, Amsterdam (NL); Gerardus Johannes Maria Gruter, Amsterdam (NL)

(21) Appl. No.: 17/615,792

(22) PCT Filed: May 26, 2020
(86) PCT No.: PCT/EP2020/064514

§ 371 Date: Dec. 1, 2021

(30) Foreign Application Priority Data
May 27, 2019 (EP) 19176761.5

(51) Int. Cl. C13K 13/00; C13K 1/02; D21C 3/04

(52) U.S. Cl. CPC C13K 13/002; C13K 1/02; D21C 3/04

(57) ABSTRACT

A process for hydrolyzing at least part of the hemicellulose and at least part of the cellulose of a particulate solid material comprising cellulose, lignin, and from 10 to 60% by weight of hemicellulose, wherein said hemicellulose comprises xylose in an amount of from 40 to 100% by weight, on the basis of hemicellulose, said process being conducted in at least one reactor comprising said particulate solid material and interstitial space. The process comprises two hydrolysis steps using hydrochloric acid, separated by a displacement step wherein a water-immiscible displacement fluid displaces part of the hydrochloric acid containing hydrolysate products from the interstitial space in the reactor. In the present process, a particulate solid material is used of which the hemicellulose is high in xylose (xylan).

### INTRODUCTION

The invention relates to a process for hydrolyzing at least part of the hemicellulose and at least part of the cellulose of a particulate solid material comprising cellulose, lignin, and from 10 to 60% by weight of hemicellulose, wherein said hemicellulose comprises xylose in an amount of from 40 to 100% by weight, on the basis of hemicellulose, said process being conducted in at least one reactor comprising said particulate solid material and interstitial space. More specifically, said conversion is a two-step acid hydrolysis using hydrochloric acid, with in between these two steps the use of a water-immiscible displacement fluid that can displace at least part of the aqueous hydrochloric acid (further containing hydrolysis products) from the interstitial space. Even more specifically, said process may comprise a further step to convert xylose in a hydrolysate produced in this invention to xylitol, and/or the particulate solid material may comprise 50 to 100% by weight of the total weight of particulate solid material of one or more of coconut shells or parts thereof.

### BACKGROUND OF THE INVENTION

Several processes are known for the production of saccharides out of material containing cellulose. The saccharides so produced can be used as renewable sources (or intermediates) of chemical building blocks or for use in generating carriers of energy, such as ethanol. One of these processes relate to a hydrolysis of the cellulose using a strong aqueous acid. In such process, the saccharides are typically obtained as a mixture of mono-, di- and oligo-saccharides dissolved in the aqueous acid. Various sources can be used as cellulosic material. It is advantageous if sources can be used that do not directly compete with material used in food production. Examples of cellulosic material that do not compete with the food chain are so-called ligno-cellulosic materials, which contain next to cellulose also lignin. Such ligno-cellulosic materials can be found in vegetable biomass such as wood and materials that are made of wood. Depending on the source of the vegetable biomass the ligno-cellulosic material will also contain varying amounts of hemicellulose, next to some minor components (e.g. extractives, ash) and moisture.

A process for the hydrolysis of wood using strong hydrochloric acid is known as the Bergius-Rheinau process (F. Bergius, Current Science Vol. 5, No. 12 (June 1937), pp. 632-637). Wood as source of cellulose to be hydrolysed contains considerable amounts of hemicellulose. In processes for obtaining saccharides by hydrolysis of cellulose using a strong acid, part of hemicellulose being present will also be hydrolysed under the influence of strong aqueous acid solutions. Hydrolysis of hemicellulose generally yields a mixture which may comprise one or more of xylose, arabinose, mannose, glucose and their oligomers as saccharides, i.e. a mixture of pentoses and hexoses (or C5- and C6-saccharides) and their oligomers. Hydrolysis of cellulose on the other hand will yield (mainly) hexoses (C6-sacchharides). It may be an advantage to have a process for producing hexoses out of a ligno-cellulosic source such as wood in which the cellulose is hydrolysed selectively. The process as disclosed in US 2945777, which is the Bergius-Rheinau process as modified by T Riehm (or simply: modified Bergius-Rheinau process), aims to achieve this objective. In this process, the acid hydrolysis occurs in two stages: a first hydrolysis or pre-hydrolysis using hydrochloric acid at a concentration of 34-37%, followed by a second hydrolysis using hydrochloric acid at a concentration of 40-42%. In the pre-hydrolysis (mainly) the hemicellulose is hydrolysed, yielding a pre-hydrolysate containing a mixture of pentoses and hexoses and their oligomers. The hydrolysis carried out thereafter will hydrolyse (mainly) the cellulose, yielding a hydrolysate rich in a mixture of hexoses and their oligomers. This facilitates obtaining a stream rich in hexoses.

A further improvement of the above process of US2945777 is one in which the aqueous pre-hydrolysate (of the hemicellulose fraction of the starting material) and the aqueous hydrolysate (of the cellulose fraction of the starting material) can largely be kept separate. A process in which in between the hydrolysis and pre-hydrolysis the material to be hydrolysed is treated with a non-aqueous, preferably hydrophobic, displacement fluid achieves this. This has been set out in non-pre-published patent application PCT/EP2019/052404. The process in this reference uses a system of at least one reactor in which wood chips are present as a stationary phase, which stationary phase is flooded with hydrochloric acid of e.g. 37% for a pre-hydrolysis step. After carrying out the pre-hydrolysis (of the hemicellulose) to a sufficient degree, a non-aqueous displacement fluid is fed to the reactor, which pushes out at least part of the aqueous hydrochloric acid and hydrolysis products. Thereafter, the non-aqueous displacement fluid is pushed out in turn by feeding to the reactor the hydrochloric acid solution of higher concentration, e.g. 42%, to effect the hydrolysis (of the cellulose).

In the process of the non-prepublished patent application referred to above, after the pre-hydrolysis is sufficiently complete, non-aqueous displacement fluid is fed to the reactor. When feeding the reactor with non-aqueous displacement fluid to displace the aqueous pre-hydrolysate from the reactor initially pre-hydrolysate comes out (followed by the non-aqueous displacement fluid if continued long enough). This pre-hydrolysate will be pushed out by the displacement fluid as long as inlet of displacement fluid and exit of pre-hydrolysate are carefully chosen, taking into account the density of both aqueous pre-hydrolysate and non-aqueous displacement fluid. More specifically, if the non-aqueous displacement fluid has a density lower than that of the aqueous pre-hydrolysate and is pumped into the reactor at the top, and the aqueous pre-hydrolysate can be collected at the bottom, the displacement fluid pushes (like a plug) the aqueous pre-hydrolysate out at the bottom.

The aim of the above referred process is to be able to collect most of the pre-hydrolysate (aimed at hydrolyzing hemicellulose) separate from the hydrolysate (aimed at hydrolyzing cellulose), as this facilitates further processing and valorization of the hydrolysates of cellulose and hemicellulose separately. Hydrolysis of hemicellulose may yield various monomers. A valuable product from cellulose hydrolysis is glucose.

There is a desire for a process on obtaining useful chemical components from biomass, which process and starting material is preferably such that valuable components can be obtained and low cost starting material or waste material can be used to produce such components from. More specifically, there is a desire for a process on hydrolyzing particulate solid matter which comprises cellulose, hemicellulose and lignin, which process can yield (to a large extent) separate streams of hydrolysate of cellulose and hydrolysate of hemicellulose, wherein the hydrolysate of hemicellulose can be utilized as a valuable product.

### SUMMARY OF THE INVENTION

It has now been found that the objectives as above could be achieved, at least in part, by a process for hydrolyzing at least part of the hemicellulose and at least part of the cellulose of a particulate solid material comprising cellulose, lignin, and from 10 to 60% by weight of hemicellulose, wherein said hemicellulose comprises xylose in an amount of from 40 to 100% by weight, on the basis of hemicellulose, said process being conducted in at least one reactor comprising said particulate solid material and interstitial space, which processes comprises the subsequent steps of:
a. contacting said particulate solid material with an aqueous hydrochloric acid solution by adding to the reactor a first hydrochloric acid solution having a hydrochloric acid concentration of at least 30% and not more than 42%, based on the weight amount of water and hydrochloric acid in the first hydrochloric acid solution, yielding a remaining particulate solid material and a first aqueous hydrolysate product solution;
b. displacing at least part of said first aqueous hydrolysate product solution from the interstitial space with a water-immiscible displacement fluid;
c. removing at least part of the water-immiscible displacement fluid of step b. and contacting the particulate solid material resulting from step b. with an aqueous hydrochloric acid solution by adding to the reactor a second hydrochloric acid solution, wherein the second hydrochloric acid solution has a hydrochloric concentration of at least 40% and less than 51%, based on the weight amount of water and hydrochloric acid in the second hydrochloric acid solution whilst said second hydrochloric acid solution has a hydrochloric acid concentration which is the same or higher than the first hydrochloric acid solution added in step a., yielding a remaining particulate solid material and a second aqueous hydrolysate product solution;
and which process comprises a further step d. in which the first aqueous hydrolysate product solution is subjected to a process to convert xylose and its oligomers to xylitol.

In the above process the convention of xylose to xylitol may be achieved by any suitable process known in the art. It may be preferred for this purpose that step d. in the above process comprises hydrogenation using a metal catalyst or fermentation.

The objectives as stated above may also be achieved, at least in part, by a process for hydrolyzing at least part of the hemicellulose and at least part of the cellulose of a particulate solid material comprising cellulose, lignin, and from 10 to 60% by weight of hemicellulose, wherein said hemicellulose comprises xylose in an amount of from 40 to 100% by weight, on the basis of hemicellulose, said process being conducted in at least one reactor comprising said particulate solid material and interstitial space, which processes comprises the subsequent steps of:
a. contacting said particulate solid material with an aqueous hydrochloric acid solution by adding to the reactor a first hydrochloric acid solution having a hydrochloric acid concentration of at least 30% and not more than 42%, based on the weight amount of water and hydrochloric acid in the first hydrochloric acid solution, yielding a remaining particulate solid material and a first aqueous hydrolysate product solution;
b. displacing at least part of said first aqueous hydrolysate product solution from the interstitial space with a water-immiscible displacement fluid;
c. removing at least part of the water-immiscible displacement fluid of step b. and contacting the particulate solid material resulting from step b. with an aqueous hydrochloric acid solution by adding to the reactor a second hydrochloric acid solution, wherein the second hydrochloric acid solution has a hydrochloric concentration of at least 40% and less than 51%, based on the weight amount of water and hydrochloric acid in the second hydrochloric acid solution whilst said second hydrochloric acid solution has a hydrochloric acid concentration which is the same or higher than the first hydrochloric acid solution added in step a., yielding a remaining particulate solid material and a second aqueous hydrolysate product solution;
and wherein the particulate solid material comprises 50 to 100% by weight of the total weight of particulate solid material of one or more of coconut (Cocos nucifera) shells or parts thereof.

### DETAILED DESCRIPTION OF THE INVENTION

“Hemicellulose comprises xylose” is herein to be understood as a hemicellulose comprising monomers of xylose as part of the hemicellulose polymer.

“Water-immiscible” herein means, in connection to the displacement fluid and displacement liquid, that such displacement fluid or displacement liquid has a solubility in water of less than 3 g displacement fluid (or displacement liquid) per litre of water, at 20° C. and atmospheric pressure. Preferably, such solubility is less than 2 g/L, even more preferably less than 1 g/L, under such conditions.

“Interstitial space” herein means the voids in a reactor filled with particulate solid material, or in other words the space inside the reactor but outside the particulate solid material.

It was found that the process of the above referred non pre-published patent application could be made even more attractive from a commercial point of view by ensuring the hemicellulose part of the biomass used as a starting material (i.e. the specified particulate solid material) is relatively high in its content of xylose, as such xylose may easily be turned into xylitol, which is a high value product. By doing so, economic advantages of this process are improved by ensuring not only hydrolyzing cellulose leads to high value products, but also hydrolyzing hemicellulose of a specific composition. Hence, the present invention relates to a similar process as in PCT/EP2019/052404, yet firstly the starting material contains hemicellulose which contains a relatively high proportion of xylose, and secondly the process either contains a further process step in which the xylose is converted into xylitol, and/or the starting material comprises solid material of one or more of coconut (Cocos nucifera) shells or parts thereof. The reason for the latter preference is threefold: coconut shells contain a high proportion of xylose, coconut shells are often waste material and thus cheaply available (thus providing economic and environmental benefit) and thirdly coconut shells can easily be processed as particulate matter in the present process (leaving interstitial space in the reactor).

In the process according to the present invention, it is preferred that the particulate solid material has a certain amount of hemicellulose to enjoy the benefits set out. Hence, in the present invention it is preferred that the particulate solid material has a hemicellulose content of from 15 to 50%, preferably from 20 to 40%, by weight on the particulate solid material. Likewise, of the hemicellulose present preferably all or a substantial part is xylose. Hence, in the present invention it is preferred that the hemicellulose used in the process according to the present invention comprises xylose in an amount of from 50 to 99% by weight, preferably in an amount of from 55 to 95% by weight, based on the hemicellulose.

Materials that suit the above preferred choices for the particulate solid material are e.g. materials from coconuts, from rice plants, and from sugar cane plants. Ideally, the particulate solid material utilized in the now claimed process is the non-edible part of these plants (as the edible parts represents value in itself). Hence, in the present invention it is preferred that the particulate solid material comprises 50 to 100% by weight of the total weight of particulate solid material of one or more of coconut (Cocos nucifera) shells or parts thereof, stalks and/or leaf or parts thereof of rice (Oryza sativa), stalks and/or leaf or parts thereof of bagasse (Saccharum) (the latter preferably being Saccharum officinarum). Of the coconut shells the endocarp is the preferred part. Hence, in the present invention it is preferred that the particulate solid material comprises 50 to 100% by weight of endocarp of coconut (Cocos nucifera), preferably chips of such endocarp.

The presently claimed process yields a liquid product stream that contains products of the acid hydrolysis of hemicellulose. The presently claimed process relies on hydrolysis using concentrated hydrochloric acid. The hemicellulose-hydrolysis products may be separated from the hydrochloric acid by techniques as known in the art, such as are set out in e.g. WO2016/099272 and WO2017/082723. As stated, any desired conversion of xylose into xylitol may be performed by any known process.

For the embodiment of the present invention wherein the process relates to a process wherein the particulate solid material comprises 50 to 100% (preferably 80-100%) by weight of the total weight of particulate solid material of one or more of coconut (Cocos nucifera) shells or parts thereof, it is preferred that the particulate solid material comprises 50 to 100% (preferably 80-100%) by weight of the total weight of particulate solid material of coconut (Cocos nucifera) shells from the endocarp, mesocarp, or exocarp, or mixtures thereof. Most preferred (as such particles can be utilised well in the reactor concerned, easily giving interstitial space) are particles from the endocarp. Hence, in the present invention it is preferred that that the particulate solid material comprises 50 to 100% (preferably 80-100%) by weight of endocarp of coconut (Cocos nucifera), preferably chips of such endocarp. In order to facilitate the process (e.g. flow of the liquid through the reactor) it is preferred that the particulates have a certain size. Following this, it is preferred that the particulate solid material used in the present invention is a solid material of which the particles prior to hydrolyzing step a. have a particle size of at least P16A and at most P100, preferably P45A or P45B, conforming European standard EN 14961-1 on solid biofuels.

As stated above, in the processes of the present invention the displacement fluid can effect that the hydrolysis product of the first step (step a, being rich in hydrolysis products of hemicellulose) can be kept separate to a large extent of the hydrolysis products of the second hydrolysis stage (step c., which uses hydrochloric acid of a higher concentration, mainly containing hydrolysis products of cellulose). In such processes, the removal of at least part of the water-immiscible displacement fluid in step c. is preferably effected by adding to the reactor a second hydrochloric acid solution thereby displacing the water-immiscible displacement fluid from the interstitial space. In other words, similar as the displacement fluid may be used to push out the hydrolysis products of stage a, the stronger hydrochloric acid of step c may be used to drive out the displacement fluid in turn.

In the processes according to the present invention the displacement fluid is water-immiscible, which has been defined as a liquid that has a solubility in water of less than 3 g liquid per litre of water, at 20° C. and atmospheric pressure. Preferably, the displacement fluid in the present invention has a solubility in water of less than 2 g/L, even more preferably less than 1 g/L at 20° C. and atmospheric pressure. In the now claimed processes the water-immiscible liquid is preferably a hydrocarbon liquid, preferably having a boiling temperature of at least 80° C. at a pressure of 0.1 mPa, and preferably has a viscosity at 20° of 5 cP or less.

Examples of suitable displacement fluids according to the present invention comprise or consist of one or more alkanes chosen from the group consisting of cyclic hexane, normal hexane, iso-hexane and other hexanes, normal heptane, iso-heptane and other heptanes, normal octane, iso-octane and other octanes, normal nonane, iso-nonane and other nonanes, normal decane, iso-decane and other decanes, normal undecane, iso-undecane and other undecanes, normal dodecane, iso-dodecane and other dodecanes, normal tridecane, iso-tridecane and other tridecanes, normal tetradecane, iso-tetradecane and other tetradecanes, normal pentadecane, iso-pentadecane and other pentadecanes, normal hexadecane, iso-hexadecane and other hexadecanes.

The processes of the present invention will work well if in a reactor packed with biomass particulates there is still some interstitial space, through which the hydrochloric acid and displacement fluid can percolate. For such, in the present invention it is preferred that the reactor comprising said particulate solid material and interstitial space has a porosity calculated as Vᵢₙₜₑᵣₛₜᵢₜᵢₐₗ _{space} / V_{bulk} of between 0.1 and 0.5, preferably said porosity is between 0.2 and 0.4, wherein V_{bulk}= Vᵢₙₜₑᵣₛₜᵢₜᵢₐₗ _{space} + V_{particulates}, and V is the volume in such.

The invention further relates to the use of (a process comprising) acid hydrolysis for obtaining xylose or xylitol from particulate solid material of one or more of coconut (Cocos nucifera) shells or parts thereof. In such, the acid hydrolysis is preferably performed under the conditions as specified herein, such as e.g. using hydrogen chloride in a concentration of between 30 and 50%.

### EXAMPLES

### Example 1

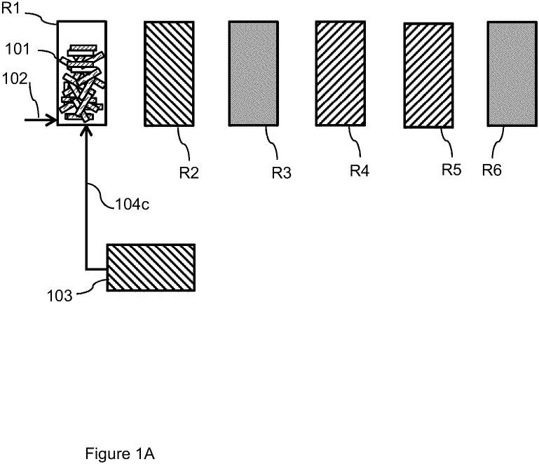

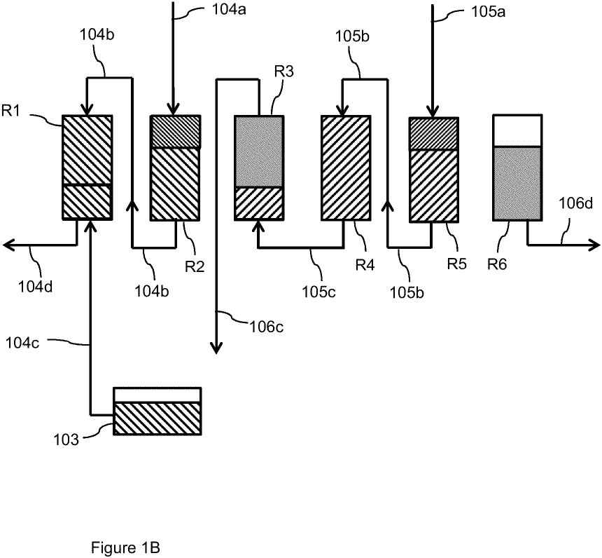

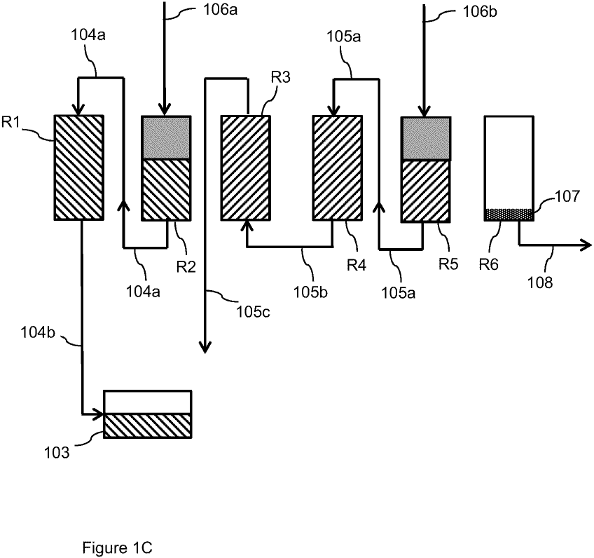

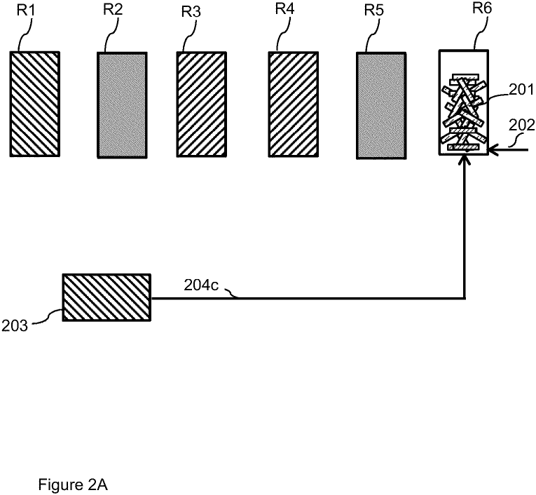

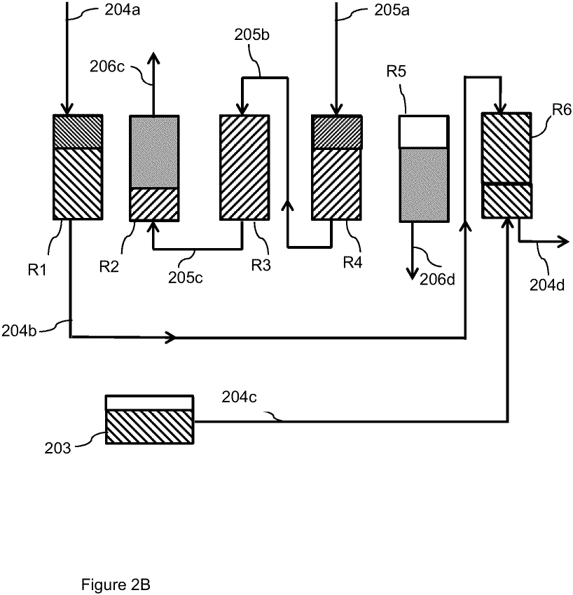

Non-limiting FIGS. 1A, 1B, 1C, 2A and 2B illustrate an example of the process according to the invention.

The illustrated process is carried out in a reactor sequence of 6 hydrolysis reactors (R1 to R6). The hydrolysis reactors are operated at a temperature of 20° C. and a pressure of 0.1 MegaPascal. The process is operated in a sequence of cycles, each cycle being carried out within a 8 hour cycle period.

FIG. 1A illustrates the start of a new cycle. At the start of a new cycle, dried wood chips (101) have just been loaded into reactor (R1) via solid inlet line (102). Reactor (R2) contains an intermediate prehydrolysate solution and a solid material containing cellulose and lignin. The hemicellulose is already at least partly hydrolysed. Reactor (R3) contains a displacement fluid (such as for example iso-octane) and a solid material containing cellulose and lignin. Reactors (R4) and (R5) each contain an intermediate hydrolysate solution. The intermediate hydrolysate solution in reactor (R4) can contain a higher amount of saccharides than the intermediate hydrolysate solution in reactor (R5), as explained below. In addition reactors (R4) and (R5) contain a solid material containing lignin. The cellulose is already at least partly hydrolysed. Reactor (R6) contains a displacement fluid (such as for example iso-octane) and a residue. The residue is a solid material containing lignin.

As illustrated in FIG. 1B, during a first part of the cycle, reactor (R1) is flooded with a plug (104c) of intermediate prehydrolysate solution coming from a storage vessel (103), a plug (104a) of fresh first aqueous hydrochloric acid solution is introduced to reactor (R2), a plug (105a) of fresh second aqueous hydrochloric acid solution is introduced to reactor (R5) and a plug (106d) of displacement fluid is drained from reactor (R6).

After reactor (R1) has been flooded with a plug (104c when going into R1, 104d when being pushed out of R1) of intermediate prehydrolysate solution coming from a storage vessel (103), a plug (104a) of fresh first aqueous hydrochloric acid solution, having a hydrochloric acid concentration of 37.0 wt. % and containing essentially no saccharides yet, is introduced into reactor (R2), thereby pushing forward a plug (104b) of intermediate pre-hydrolysate solution, containing hydrochloric acid in a concentration of about 37.0 wt. %, but also containing already some saccharides (i.e. saccharides derived from solid material that was residing in reactor (R2)), from reactor (R2) into reactor (R1).The plug (104b) of intermediate pre-hydrolysate solution, pushes the plug (104d) out from reactor (R1). Plug (104d) previously contained intermediate pre-hydrolysate solution, but has now taken up sufficient saccharides and has become a final first hydrolysate product solution. Such final first hydrolysate product solution can suitably be forwarded to one or more subsequent processes or devices, where optionally hydrochloric acid could be removed from the pre-hydrolysate solution and recycled.

During the same first part of the cycle, a plug (105a) of fresh second aqueous hydrochloric acid solution, having a hydrochloric acid concentration of 42.0 wt. % and containing essentially no saccharides yet, is introduced into reactor (R5), thereby pushing forward a plug (105b) of intermediate hydrolysate solution, containing hydrochloric acid in a concentration of about 42.0 wt. %, but also containing already some saccharides (i.e. derived from the solid material that was residing in reactor (R5)), from reactor (R5) into reactor (R4). This plug (105b) in its turn pushes forward a second plug (105c) of intermediate hydrolysate solution, containing hydrochloric acid in a concentration of about 42.0 wt. %, but also containing saccharides (i.e. derived from solid material that was residing in previous reactors), from reactor (R4) into reactor (R3). Whilst being pushed from reactor (R5) into reactor (R4) and further into reactor (R3), the intermediate hydrolysate solution absorbs more and more saccharides from the solid material remaining in such reactors from previous stages. The saccharide concentration of the intermediate hydrolysate solution advantageously increases, thus allowing a saccharide concentration to be obtained, that is higher than the saccharide concentration obtained in a batch-process.

The plug (105c) of intermediate hydrolysate solution being pushed from reactor (R4) into reactor (R3), pushes a plug (106c) of displacement fluid out of reactor (R3).

During this same first part of the cycle, further a plug (106d) of displacement fluid is drained from reactor (R6), leaving behind a residue containing lignin.

During a second part of the cycle, as illustrated by FIG. 1C, a plug (106a) of displacement fluid is introduced into reactor (R2). This plug (106a) may or may not contain parts of the plug (106c) of displacement fluid that was pushed out of reactor (R3). Advantageously, the volume of displacement fluid in plug (106a) can be adjusted, for example by adding more or less displacement fluid, to compensate for volume losses due to the reduction of solid material volume. This allows one to ensure that all reactors remain sufficiently filled with volume and it allows one to maintain a sufficient flowrate.

The plug (106a) of displacement fluid being introduced in reactor (R2), suitably pushes forward plug (104a) that was residing in reactor (R2). Plug (104a), previously contained merely fresh first aqueous hydrochloric acid solution, but has in the meantime taken up saccharides from the solid material in reactor (R2) and has become an intermediate pre-hydrolysate solution. Plug (104a) is pushed out of reactor (R2) into reactor (R1), thereby pushing forward plug (104b) of intermediate pre-hydrolysate solution out of reactor (R1) into storage vessel (103) as illustrated in FIG. 1C.

In addition, suitably, a plug of displacement fluid (106b) is introduced into reactor (R5). The plug (106b) of displacement fluid being introduced in reactor (R5), suitably pushes forward plug (105a) that was residing in reactor (R5). Plug (105a), previously contained merely fresh second aqueous hydrochloric acid solution, but has in the meantime taken up saccharides from the solid material in reactor (R5) and has become an intermediate hydrolysate solution. Plug (105a) is pushed out of reactor (R5) into reactor (R4), thereby pushing forward plug (105b) of intermediate pre-hydrolysate solution out of reactor (R4) into reactor (R3). The plug (105b) of intermediate pre-hydrolysate solution, pushes forward plug (105c) that was residing in reactor (R3). Plug (105c), previously contained intermediate hydrolysate solution, but has now taken up sufficient saccharides and has become an aqueous second hydrolysate product solution. Such second hydrolysate product solution can also be referred to as a hydrolysate product solution. Plug (105c) of second hydrolysate product solution is pushed out from reactor (R3). Such second hydrolysate product solution can suitably be forwarded to one or more subsequent processes or devices, where optionally hydrochloric acid could be removed from the hydrolysate solution and recycled.

During this same second part of the cycle, residue (107) containing lignin can suitably be removed from reactor (R6) via solid outlet line (108) and reactor (R6) can be loaded with a new batch of dried wood chips (shown as (201) in FIG. 2A).

The cycle has now been completed and all reactors have shifted one position in the reactor sequence. That is:
reactor (R6) has now shifted into the position previously occupied by reactor (R1);
reactor (R1) has now shifted into the position previously occupied by reactor (R2);
reactor (R2) has now shifted into the position previously occupied by reactor (R3);
reactor (R3) has now shifted into the position previously occupied by reactor (R4);
reactor (R4) has now shifted into the position previously occupied by reactor (R5); and
reactor (R5) has now shifted into the position previously occupied by reactor (R6).

As indicated, the above cycle takes about 8 hours. A subsequent cycle can now be started.

The situation wherein all reactors have shifted one position has been illustrated in FIG. 2A. FIG. 2A illustrates the start of a subsequent cycle, at a time “t+8 hours”. The dried wood chips in what was previously reactor (R6) and is now reactor (R1) can be flooded with a plug (204c) of intermediate pre- hydrolysate solution withdrawn from the storage vessel (103). This is the same intermediate pre-hydrolysate solution that was stored in such storage vessel (103) as plug (104b) of intermediate pre-hydrolysate solution in the second part of the previous cycle, and illustrated in FIG. 1C. The subsequent cycle can be carried out in a similar manner as described above for the preceding cycle. Such is illustrated in FIG. 2B, where numerals (201), (202), (204a-d), (205a-c) and (206a-d) refer to features similar to the features referred to by numerals (101), (102), (104a-d), (105a-c) and (106a-d) in FIG. 1B.

It is noted that all pre-hydrolysate and hydrolysate solutions in the above examples are suitably aqueous hydrolysate solutions, respectively aqueous pre-hydrolysate solutions.

### Example 2: Hydrolysis of Woodchips in a Continuous Operation

### Experimental Set-Pp

In this lab-scale example on a vertical board 7 tubular reactors made of transparent PVC were mounted in a row, the reactors having a height of 0.53 m and a diameter of 0.053 m. Each reactor was equipped with a glass filter plate pore size 0 at the bottom and top (removable at both ends, to allow filling with woodchips and emptying lignin particles). Both bottom and top of each reactor had a liquid tight closure screwed at both ends, said closure having one (central) opening for allowing liquids to be fed to the reactor or liquids to be drained or pumped out of the reactor, with a diameter of 1/16 inch. All reactors were identical.

Storage tanks were present for: fresh 37% hydrochloric acid solution, tridecane displacement fluid, fresh 41-42% HCl solution (cooled to 0° C.). Also present was a tank for receiving a mixture of both used displacement fluid as well as pre-hydrolysate as well as a tank for receiving a mixture of both used displacement fluid as well as hydrolysate. All tanks had an open vent so there was not pressure build up.

Linked to each reactor were two 10-port selector valves operated by an electric drive: one with the inlet of selector valve connected to the outlet at the bottom of the reactor, one with the inlet of the selector valve connected to the outlet at the top of the reactor. Between inlet of selector valve and outlet of reactor was a section of transparent tube (material PTFE, diameter about 1/16 inch, length varying for different reactors, at about 10 cm). Mounted onto each tube between reactor outlet (top and bottom) and selector valve was an optical sensor. The sensor was a combination of a yellow LED on one side of a 1/16^{th} inch quartz tube (connected to the PTFE tube) and a light detector on the other side. The electronic output of the sensor was linked via a computer to one of five pumps.

Outlets of the selector valve were connected to the inlets (top and bottom) of the neighboring reactors (two), and with the storage tanks (4). The connecting tube of the outlets was of the same material and diameter as at the inlets.

Five pumps were present: one for pumping in fresh 37% acid at the start (flood filling), one for pumping 37% hydrochloric acid during the process from a storage tank, one for pumping 42% hydrochloric acid from a storage tank, one for displacement fluid to be used in between pre- and main hydrolysis, one for displacement fluid after the main hydrolysis. The pumps were connected to manifolds, both at the top and bottom inlet.

### Materials

Chips of rubberwood. Size of woodchips: about 50% had a size of 8-16 mm, about 50% had a size of 16-45 mm. The chips had a moisture content of about 5%. The content of the reactors filled with the woodchips had a bulk density of about 260 kg/m³.
Hydrochloric acid of a concentration of about 37%
Hydrochloric acid of a concentration of 41-42%, as made in-situ by a conventional method.
Tridecane as non-aqueous displacement fluid.

### Procedure

At the start of the experiment all reactors were empty, clean, and the hydrochloric acid solutions and displacement fluid were present in sufficient quantities in the storage tanks. Then all reactors were filled with approximately 300 g of wood chips, sieve places and closures put in place and tubing connected.

The system was operated along the scheme as set out in table 1, which states what goes in each reactor and when. Herein, the abbreviations have the following meaning: R1, R2, .... R6, R7 as headers of the columns: reactor 1, reactor 2, .... reactor 6, reactor 7.

In the table

| | |
|---|---|
| N | no operation |
| FF | flood filling |
| S | stationary |
| FP1 | fresh plug of 37% hydrochloric acid |
| DF1 | displacement fluid to displace 37% hydrochloric acid pre-hydrolysate |
| FP2 | fresh plug of 42% hydrochloric acid |
| DF2 | displacement fluid to displace 42% hydrochloric acid hydrolysate |
| R1 | flow coming from reactor 1 into reactor 2 |
| R2 | flow coming from reactor 2 into reactor 3 |
| R3 | flow coming from reactor 3 into reactor 4; and so forth |
| FIN | reaction finalized, removing reactor for offloading of lignin. |

Each row in this table was planned to last for about 6 hours.

For this experiment, for an average amount of biomass of 300 g a theoretical amount of fresh 37% hydrochloric acid and fresh 42% hydrochloric acid required was calculated. The acid was pumped in at a fixed pump speed, for the time required to pump in (about) the calculated amount of acid. When it was determined that the right amount of acid was pumped in, the pump was stopped. Thereafter, displacement fluid (DF1 after FP1, and DF2 after FP2) was pumped into the reactor from the top.

The time allowed for DF1 and DF2 being pumped in was 6 hours. As will follow, the sensors at the bottom of each reactor were triggered earlier than that: after about 2-3 hours, by the change from dark coloured (pre)-hydrolysate to clear DF liquid. The sensor tripping caused the pump pumping in DF liquid to stop. The next step was only started after the end of the 6 hour time frame.

The 16 hours pre-hydrolysis was made up of 1 hour flood fill, 2 hours fresh plug into reactor R+1, 6 hours displacement fluid into reactor R+1, 1 hour wait (as R-1 flood fills), 2 hours fresh plug into this reactor, 6 hours displacement in to this reactor. The flow of acids were controlled by timers. Ideally, the pump would be running for the full phase time, as this keeps the flow in the reactors stable and therefore the reaction stable, but that was not achieved yet. The flow of displacement fluid was controlled by optical sensors.

In practice:

Cycle 1 at t = 0 hours: for the first reaction cycle reactor 1 was flood-filled from the bottom in about 30 minutes with fresh 37% acid. The system then was idle for 8 hours, as the hydrolysate needed to build up enough color on start up for the required optical sensor colour difference. At the end of this period (t=8 hours) the reactor 2 was flood filled from the bottom with fresh 37% acid.

Thereafter (t=8.5 hours, start cycle 2) fresh hydrochloric acid solution at 37% was fed to the top of reactor 1, pushing out the obtained pre-hydrolysate at the bottom of reactor 1, which was fed to the top of reactor 2. At the bottom outlet of reactor 2 pre hydrolysate was collected. By doing it this way, the reactor stays completely filled with biomass to be hydrolysed and liquid solution, without any headspace or vacuum. The pre-hydrolysate was collected in a storage tank.

Subsequently (t = 16 hours) displacement fluid (DF1) was pumped in at the top of reactor 1, which DF1 pushed out pre-hydrolysate of the bottom of reactor 1. This step was programmed to last 8 hours but the pump was stopped when the sensor at the bottom of R1 sensed the step change from pre-hydrolysate (dark) to displacement fluid (clear due to its immiscibility with HCl/pre-hydrolysate).

Reactor 3 was now flood filled while reactor 2 stayed stationary for 30 mins, after which fresh 37% hydrochloric acid was at the top of reactor 2, followed by displacement fluid DF1.

Reactor 1 was now finished with pre-hydrolysis and DF1, and entered the stage of main hydrolysis. For this, 42% hydrochloric acid (FP2) was added to the bottom of reactor 1 for about 16 hours which drove out the displacement fluid at the top of reactor 1.

The main hydrolysate was in this experiment collected jointly with the displacement fluid that pushed it out (DF2) and collected in one tank initially (after which separation by hand by separation funnel of the two immiscible phases was conducted).

[image]

Table 1: sequence of activities in reactors 1 to 7.

### Moment A in Table 1 (Time = T + 3 Hours)

At the outlet at the bottom of reactor R1, the sensor “sensed” a colour change of the flow changing from FP2 (very dark coloured to almost black) to DF2 (clear) and sent a signal to the computer which triggered the pump for DF2 to stop pumping in DF2. After this, reactor R1 was emptied.

### Moment B in Table 1 (Time = T + 2 Hours)

At the outlet at the bottom of reactor R4, the sensor “sensed” a colour change of the flow changing from FP1 (very dark coloured to almost black) to DF1 (clear) and sent a signal to stop the pump that pumps in DF1. After this, liquid R3 was pumped in from the bottom and DF1 was released at the top.

### Summary Mass Flows in

Table 2 gives the mass flows into the system in this experiment. In reactor 7, during fresh 42% acid flowing in a pump failed.

TABLE 2

mass flows in experiment

| | | R1 | R2 | R3 | R4 | R5 | R6 | R7 |
|---|---|---|---|---|---|---|---|---|
| Biomass in | g | 301.2 | 304.4 | 331.5 | 312.4 | 290.3 | 317.4 | 287.9 |
| Mass 37% acid flood filled | g | 1043 | 842.3 | 847 | 1014. 9 | 907 | 1108. 8 | 1187. 4 |
| 37% fresh acid | g | 373.4 | 397.8 | 385.4 | 255.5 | 384.8 | 384.8 | 409.2 |
| ratio fresh 37% / biomass | g/g | 1.2 | 1.3 | 1.2 | 0.8 | 1.3 | 1.2 | 1.4 |
| DF1 mass | g | 436.1 | 447.4 | 429.7 | 499.6 | 477.1 | 407.5 | 407.5 |
| Pre-hydrolysate to DF1 sensor tripping | | y | y | y | y | y | y | y |
| DF1 actual time | h | 2.2 | 2 | 2 | 1.3 | 1.8 | 1.5 | 1.5 |
| 42% fresh acid | g | 1947. 8 | 500 | 530 | 500 | 535 | 510 | 10* |
| Ratio fresh 42% / biomass | g/g | 6.5 | 1.6 | 1.6 | 1.6 | 1.8 | 1.6 | 0* |
| DF2 mass | | 815 | 693 | 550 | 672 | 733 | 693 | 448 |
| DF2 actual time | h | 3.3 | 2.8 | 2.7 | 2.8 | 3.0 | 2.8 | 1.8* |
| Mass wet lignin out | g | 494 | 505 | 562 | 541 | 513 | 596 | 599 |
| Mass dry lignin out | g | 79 | 100 | 99 | 103 | 95 | 111 | 155 |
| Retained liquid | g | 416 | 405 | 463 | 438 | 418 | 484 | 444 |
| Hydrolysis mass loss (biomass cf lignin) | yield (wt%) | 26% | 33% | 30% | 33% | 33% | 35% | 54% |
| Theoretical lignin | g | 70.8 | 71.5 | 77.9 | 73.4 | 68.2 | 74.6 | 67.6 |
| Theoretical hydrolysis efficiency | % | 97% | 88% | 92% | 88% | 88% | 85% | 60% |

*: pump failed.

### Sensor Activity

### Results

Part of the results, e.g. on the lignin and efficiency of hydrolysis are given in table 2. Further results on the hydrolysates are in table 3. Although for lignin the amount per reactor was measured, the liquid hydrolysates of the various reactors were jointly collected (hydrolysate and pre-hydrolysate separate). Hydrolysates were, prior to analysis on monomers, subjected to a second hydrolysis, which hydrolysed oligomers obtained in each of the pre- and main hydrolysate.

TABLE 3

analysis of hydrolysates obtained

| | Glucose yield (wt%) | Xylose + mannose yield (wt%) | Glucose purity of product |
|---|---|---|---|
| Pre-hydrolysate | 5% | 42% | 22% |
| Main hydrolysate | 37% | 34% | 73% |
| Lost (by difference) | 58% | 24% | |

As to the amount referred to as “lost” in table 3: this relates to hydrolysed sugars which are still present in the liquid which is retained in the lignin particles that are obtained from the reactors (the lignin chips are still wet) we well as any potential (hemi-)cellulose which was not hydrolysed.

### CONCLUSION

When ligno-cellulosic biomass (in the form of wood chips) was subjected to the process of the current invention in this experiment, it yielded two products: an aqueous pre-hydrolysate rich in xylose and mannose (and their oligomers) and an aqueous hydrolysate rich in glucose (and oligomers), next to lignin.

Additionally it was shown that this process can be operated in a continuous way, in the sense that one reactor was emptied of lignin (and could be filled with fresh wood chips) whilst the other reactors continued to operate, whilst also a minimum of pumps and storage tanks is needed.

The use of a non-aqueous displacement liquid secured separation of hydrolysate of hemicellulose and hydrolysate of cellulose to a large extent and contributed to steady state as well as providing a driving force for sequential reactions. Simultaneously, it also facilitated control of the various reactions without the danger of diluting the acids needed for the hydrolysis steps.

Still further, the sensors at the bottom of each reactor being triggered earlier than the allowed 6 hours (after about 2-3 hours) by the change from dark coloured (pre)-hydrolysate to clear DF liquids passing the sensor showed process control in the claimed process was possible with non-invasive sensors.

1. A process for hydrolyzing at least part of the hemicellulose and at least part of the cellulose of a particulate solid material comprising cellulose, lignin, and from 10 to 60% by weight of hemicellulose, wherein said hemicellulose comprises xylose in an amount of from 40 to 100% by weight, on the basis of hemicellulose, said process being conducted in at least one reactor comprising said particulate solid material and interstitial space, which processes comprises the subsequent steps of:
a. contacting said particulate solid material with an aqueous hydrochloric acid solution by adding to the reactor a first hydrochloric acid solution having a hydrochloric acid concentration of at least 30% and not more than 42%, based on the weight amount of water and hydrochloric acid in the first hydrochloric acid solution, yielding a remaining particulate solid material and a first aqueous hydrolysate product solution;
b. displacing at least part of said first aqueous hydrolysate product solution from the interstitial space with a water-immiscible displacement fluid;
c. removing at least part of the water-immiscible displacement fluid of step b. and contacting the particulate solid material resulting from step b. with an aqueous hydrochloric acid solution by adding to the reactor a second hydrochloric acid solution, wherein the second hydrochloric acid solution has a hydrochloric concentration of at least 40% and less than 51%, based on the weight amount of water and hydrochloric acid in the second hydrochloric acid solution whilst said second hydrochloric acid solution has a hydrochloric acid concentration which is the same or higher than the first hydrochloric acid solution added in step a., yielding a remaining particulate solid material and a second aqueous hydrolysate product solution;
and which process comprises a further step d. in which the first aqueous hydrolysate product solution is subjected to a process to convert xylose and its oligomers to xylitol.

2. The process according to claim 1, wherein the particulate solid material has a hemicellulose content of from 15 to 50%, preferably from 20 to 40%, by weight on the particulate solid material.

3. The process according to claim 1, wherein the hemicellulose comprises xylose in an amount of from 50 to 99% by weight, preferably in an amount of from 55 to 95% by weight, based on the hemicellulose.

4. The process according to claim 1, wherein the particulate solid material comprises 50 to 100% by weight of the total weight of particulate solid material of one or more of coconut (Cocos nucifera) shells or parts thereof, stalks and/or leaf or parts thereof of rice (Oryza sativa), stalks and/or leaf or parts thereof of bagasse (Saccharum) (the latter preferably being Saccharum officinarum).

5. The process according to claim 1, wherein step d. comprises hydrogenation using a metal catalyst or fermentation.

6. A process for hydrolyzing at least part of the hemicellulose and at least part of the cellulose of a particulate solid material comprising cellulose, lignin, and from 10 to 60% by weight of hemicellulose, wherein said hemicellulose comprises xylose in an amount of from 40 to 100% by weight, on the basis of hemicellulose, said process being conducted in at least one reactor comprising said particulate solid material and interstitial space, which processes comprises the subsequent steps of:
a. contacting said particulate solid material with an aqueous hydrochloric acid solution by adding to the reactor a first hydrochloric acid solution having a hydrochloric acid concentration of at least 30% and not more than 42%, based on the weight amount of water and hydrochloric acid in the first hydrochloric acid solution, yielding a remaining particulate solid material and a first aqueous hydrolysate product solution;
b. displacing at least part of said first aqueous hydrolysate product solution from the interstitial space with a water-immiscible displacement fluid;
c. removing at least part of the water-immiscible displacement fluid of step b. and contacting the particulate solid material resulting from step b. with an aqueous hydrochloric acid solution by adding to the reactor a second hydrochloric acid solution, wherein the second hydrochloric acid solution has a hydrochloric concentration of at least 40% and less than 51%, based on the weight amount of water and hydrochloric acid in the second hydrochloric acid solution whilst said second hydrochloric acid solution has a hydrochloric acid concentration which is the same or higher than the first hydrochloric acid solution added in step a., yielding a remaining particulate solid material and a second aqueous hydrolysate product solution;
and wherein the particulate solid material comprises 50 to 100% by weight of the total weight of particulate solid material of one or more of coconut (Cocos nucifera) shells or parts thereof.

7. The process according to claim 6, wherein the particulate solid material comprises 50 to 100% by weight of the total weight of particulate solid material of coconut (Cocos nucifera) shells from the endocarp, mesocarp, or exocarp, or mixtures thereof.

8. The process according to claim 6, wherein the particulate solid material is a solid material of which the particles prior to hydrolyzing step a. have a particle size of at least P16A and at most P100, preferably P45A or P45B, conforming European standard EN 14961-1 on solid biofuels.

9. The process according to claim 6, wherein the removal of at least part of the water-immiscible displacement fluid in step c. is effected by adding to the reactor a second hydrochloric acid solution thereby displacing the water-immiscible displacement fluid from the interstitial space.

10. The process according to claim 6, wherein the water-immiscible displacement fluid is a liquid that has a solubility in water of less than 3 g liquid per litre of water, at 20° C. and atmospheric pressure, preferably having a solubility of less than 2 g/L, even more preferably less than 1 g/L.

11. The process according to claim 6, wherein the water-immiscible liquid is a hydrocarbon liquid, preferably having a boiling temperature of at least 80° C. at a pressure of 0.1 mPa, and preferably has a viscosity at 20° of 5 cP or less.

12. The process according to claim 6, wherein the water-immiscible displacement fluid comprises or consists of one or more alkanes chosen from the group consisting of cyclic hexane, normal hexane, iso-hexane and other hexanes, normal heptane, isoheptane and other heptanes, normal octane, iso-octane and other octanes, normal nonane, iso-nonane and other nonanes, normal decane, iso-decane and other decanes, normal undecane, iso-undecane and other undecanes, normal dodecane, iso-dodecane and other dodecanes, normal tridecane, iso-tridecane and other tridecanes, normal tetradecane, iso-tetradecane and other tetradecanes, normal pentadecane, iso-pentadecane and other pentadecanes, normal hexadecane, iso-hexadecane and other hexadecanes.

13. The process according to claim 6, wherein the reactor comprising said particulate solid material and interstitial space has a porosity calculated as Vᵢₙₜₑᵣₛₜᵢₜᵢₐₗ _{space} / V_{bulk} of between 0.1 and 0.5, preferably a porosity of between 0.2 and 0.4, wherein V_{bulk}= Vᵢₙₜₑᵣₛₜᵢₜᵢₐₗ space + Vparticulates.

14. A use of acid hydrolysis for obtaining xylose or xylitol from particulate solid material of one or more of coconut (Cocos nucifera) shells or parts thereof.

15. The use according to claim 14, which acid hydrolysis is performed using hydrogen chloride in a concentration of between 30 and 50%.
